(19) United States
(12) Patent Application Publication
(10) Pub. No.: US 2011/0074805 A1
(43) Pub. Date: Mar. 31, 2011

(54) MEDIAN FILTER, APPARATUS AND METHOD FOR CONTROLLING AUTO BRIGHTRNESS USING THE SAME

(75) Inventors: Byoung Won HWANG, Hwaseong-si (KR); Kyoung Soo Kwon, Yongin-si (KR); Youn Joong Lee, Seoul (KR)

(73) Assignee: Samsung Electro-Mechanics Co., Ltd., Suwon-si (KR)

(21) Appl. No.: 12/626,821

(22) Filed: Nov. 27, 2009

(30) Foreign Application Priority Data
Sep. 29, 2009 (KR) 10-2009-0092320

(51) Int. Cl. G09G 5/02

(52) U.S. Cl. 345/589

(57) ABSTRACT

The present invention provides an automatic brightness control device including an illuminance sensing unit for sensing an external illuminance value in real time; a brightness classifying unit for classifying the illuminance value sensed in real time by the illuminance sensing unit into two or more configured brightness levels by comparing the sensed illuminance value with a reference illuminance value; a median filter unit for filtering a median value among the brightness levels classified by the brightness classifying unit; a gamma curve selecting unit for selecting a gamma curve which corresponds to the median value filtered by the median filter unit; and an illuminance control unit for controlling illuminance according to the gamma curve selected by the gamma curve selecting unit.

### CROSS-REFERENCE TO RELATED APPLICATIONS

This application claims the benefit of Korean Patent Application No. 10-2009-0092320 filed with the Korea Intellectual Property Office on Sep. 29, 2009, the disclosure of which is incorporated herein by reference.

### BACKGROUND OF THE INVENTION

1. Field of the Invention

The present invention relates to an automatic brightness control device and a method of automatically controlling brightness using the same; and, more particularly, to an automatic brightness control device provided with a median filter having a counting method capable of reducing an amount of arithmetic operations for controlling a noise factor of circumferential brightness and providing a fast response speed and a method of automatically controlling brightness using the same.

2. Description of the Related Art

Generally, a digital video camera provided with a Charge Coupled Device (CCD)-typed solid state imaging device or a digital image used for digital broadcasting stores image information in a pixel unit.

The image information shows characteristics of an image as data meaning, e.g., a luminance data, a color data and the like, and is allotted with a size of n-bits.

In the case of picturing or transferring an image, a noise may be included in the image information. Such a noise factor greatly degrades a visual picture quality.

For an improvement, a median filter extracts a median value from an illuminance value within a certain region and replaces the noise factor with the median value in order to reduce the noise factor.

A conventional median filter can be structured including a shift register, a buffer unit, a sorter unit and a median value selecting unit.

The shift register sequentially stores an input data; and the buffer unit calls out the data stored in the shift register to temporarily store the data.

The sorter unit rearranges the data stored in the buffer unit in order of size; and the median value selecting unit can select the median value by comparing size of the data rearranged by the sorter unit.

Arithmetic operation amount as much as a factorial of (n−1) is needed for the sorter unit to rearrange n numbers of data stored in the buffer unit in order of size.

For instance, in the case where the number of data stored in the buffer unit is 10, a number 1 data is compared with number 2 to 10 data in order to determine a size rank of the number 1 data, and a size rank of the number 2 can be determined by comparing the number 2 data with the number 3 to 10 data.

Since the sorter unit should determine each size rank of the number 3 to 10 in the manner of the above-mentioned method, arithmetic operation amount as much as 9 factorial is needed.

It is a problem of the conventional median filter that an operational speed is slowed as the number of the data is increased.

### SUMMARY OF THE INVENTION

An object of the present invention is to provide an automatic brightness control device provided with a median filter having a counting method capable of reducing an amount of arithmetic operations for controlling a noise factor of circumferential brightness with a high response speed and a method of automatically controlling brightness using the same.

In accordance with one aspect of the present invention to achieve the object, there is provided an automatic brightness control device including an illuminance sensing unit for sensing an external illuminance value in real time; a brightness classifying unit for classifying the illuminance value sensed in real time by the illuminance sensing unit into two or more configured brightness levels by comparing the sensed illuminance value with a reference illuminance value; a median filter unit for filtering a median value among the brightness levels classified by the brightness classifying unit; a gamma curve selecting unit for selecting a gamma curve which corresponds to the median value filtered by the median filter unit; and an illuminance control unit for controlling illuminance according to the gamma curve selected by the gamma curve selecting unit.

Also, the median filter of the automatic brightness control device in accordance with the present invention can include a shift register for storing the brightness levels classified by the brightness classifying unit corresponding to the illuminance value sensed in real time; a counter for storing a counting value which corresponds to the number of each brightness level into a counter address of the brightness level by sequentially counting the brightness levels stored in the shift register; and a median value detector for filtering the median value by computing the stored counting value.

Also, the shift register of the automatic brightness control device in accordance with the present invention can be provided with storing space capable of storing the brightness levels of N sensed illuminance values.

Also, the counter of the automatic brightness control device in accordance with the present invention can accumulate the counting value stored in the counter address by sequentially counting the brightness levels stored in the shift register.

Also, the counting address of the automatic brightness control device in accordance with the present invention can be determined according to a data size of the brightness levels classified by the brightness classifying unit.

Also, the median value detector of the automatic brightness control device in accordance with the present invention can filter the median value of the brightness level by comparing a value of sequentially accumulating the stored counting value with a value of dividing the number of storing space of the shift register by 2.

Also, the median value detector of the automatic brightness control device in accordance with the present invention, in the case where the sequentially accumulated value of the counting value is larger than the value of dividing the number of storing space of the shift register by 2, can filter the brightness level which corresponds to the counter address where a lastly accumulated counting value among the sequentially accumulated counting value is stored as the median value.

Also, 2^{m} numbers of the counter address can be allotted in the case where the brightness level of the automatic brightness control device in accordance with the present invention is an m-bit data.

Also, the gamma curve selecting unit of the automatic brightness control device in accordance with the present invention can select the gamma curve having a relatively large gamma value as the filtered median value is larger.

Also, the automatic brightness control device in accordance with the present invention can further include a display unit for outputting an illuminance-adjusted input image.

In accordance with another aspect of the present invention to achieve the object, there is provided a median filter including a shift register for classifying an external illuminance value sensed in real time into a plurality of brightness levels by comparing the external illuminance value with a reference illuminance value and for storing the classified brightness levels; a counter for storing a counting value which corresponds to the number of each brightness level into a counter address of the brightness level by sequentially counting the brightness levels stored in the shift register; and a median value detector for filtering the median value by computing the stored counting value.

Also, the shift register of the median filter in accordance with the present invention can be provided with storing space capable of storing the brightness levels of N sensed illuminance values.

Also, the counter of the median filter in accordance with the present invention can accumulate the counting value stored in the counter address by sequentially counting the brightness levels stored in the shift register.

Also, the counter of the median filter in accordance with the present invention address can be determined according to a data size of the brightness levels classified by the brightness classifying unit.

Also, the median value detector of the median filter in accordance with the present invention can filter the median value of the brightness level by comparing a value of sequentially accumulating the stored counting value with a value of dividing the number of storing space of the shift register by 2.

Also, in the median filter in accordance with the present invention, in the case where the sequentially accumulated value of the counting value is larger than the value of dividing the number of storing space of the shift register by 2, the brightness level which corresponds to the counter address where a lastly accumulated counting value among the sequentially accumulated counting value is stored can be filtered as the median value.

Also, 2^{m} numbers of the counter address can be allotted in the case where the brightness level of the median filter in accordance with the present invention is an m-bit data.

In accordance with still another aspect of the present invention to achieve the object, there is provided a method of computing a median value including a step of sensing an external illuminance value in real time at an illuminance sensor unit and classifying the sensed illuminance value into a plurality of brightness levels and storing the plurality of brightness levels into a shift register; a step of storing a counting value corresponding to the number of each brightness level into a counter address of the brightness level by sequentially counting the brightness levels stored in the shift register at a counter; and a step of filtering the median value by computing the stored counting value.

Also, at the step of storing the counting value corresponding to each brightness level into the counter address corresponding to ascending order of the brightness level by sequentially counting the brightness levels stored in the shift register at the counter of the median value computing method in accordance with the present invention, the counting value stored in the counter address can be accumulated by sequentially counting the brightness level stored in the shift register.

Also, the step of filtering the median value by computing the stored counting value of the median value computing method in accordance with the present invention can include a step of comparing a value of sequentially accumulating the stored counting value with a value of dividing the number of storing space of the shift register by 2; and a step of filtering the brightness level stored in the counter address where a lastly accumulated counting value among the sequentially accumulated counting value is stored as the median value in the case where the sequentially accumulated value of the counting value is larger than the value of dividing the number of storing space of the shift register by 2.

In accordance with still another aspect of the present invention to achieve the object, there is provided a method of automatic brightness control including a step of sensing an external illuminance value in real time; a step of classifying each illuminance value sensed in real time into two or more configured brightness levels by comparing the sensed illuminance value with a reference illuminance value; a step of filtering a median value among the classified brightness levels; and a step of adjusting illuminance by selecting a gamma curve corresponding to the filtered median value.

Also, the step of filtering the median value among the classified brightness levels of the automatic brightness control method in accordance with the present invention can include a step of sensing an external illuminance value in real time at an illuminance sensor unit and classifying the sensed illuminance value into a plurality of brightness levels and storing the plurality of brightness levels into a shift register; a step of storing a counting value corresponding to the number of each brightness level into a counter address of the brightness level by sequentially counting the brightness levels stored in the shift register at a counter; and a step of filtering the median value by computing the stored counting value.

Also, at the step of storing the counting value corresponding to each brightness level into the counter address corresponding to ascending order of the brightness level by sequentially counting the brightness levels stored in the shift register at the counter of the automatic brightness control method in accordance with the present invention, the counting value stored in the counter address can be accumulated by sequentially counting the brightness level stored in the shift register.

Also, the step of filtering the median value by computing the stored counting value of the automatic brightness control method in accordance with the present invention can include a step of comparing a value of sequentially accumulating the stored counting value with a value of dividing the number of storing space of the shift register by 2; and a step of filtering the brightness level stored in the counter address where a lastly accumulated counting value among the sequentially accumulated counting value is stored as the median value in the case where the sequentially accumulated value of the counting value is larger than the value of dividing the number of storing space of the shift register by 2.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a structure of the automatic brightness control device in accordance with the embodiment of the present invention;

FIG. 2 is a schematic diagram illustrating a structure of the median filter or median filter unit in accordance with the embodiment of the present invention;

FIG. 3 is a diagram for explaining each element of the median filter or median filter unit in accordance with the embodiment of the present invention;

FIG. 4 is a flow chart diagram illustrating a method of computing the median value in accordance with the embodiment of the present invention;

FIG. 5 is a flow chart diagram illustrating a method of automatic brightness control in accordance with the embodiment of the present invention; and

FIG. 6 is a diagram illustrating a gamma curve for use in the automatic brightness control device in accordance with the embodiment of the present invention.

### DETAILED DESCRIPTION OF THE PREFERABLE EMBODIMENTS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

Hereinafter, a median filter in accordance with an embodiment of the present invention, an automatic brightness control device and a method which use the median filter are described in detail with reference to the accompanying drawings. Regardless of a drawing symbol, same or corresponding elements have a same reference number and repeated explanations of these elements are omitted.

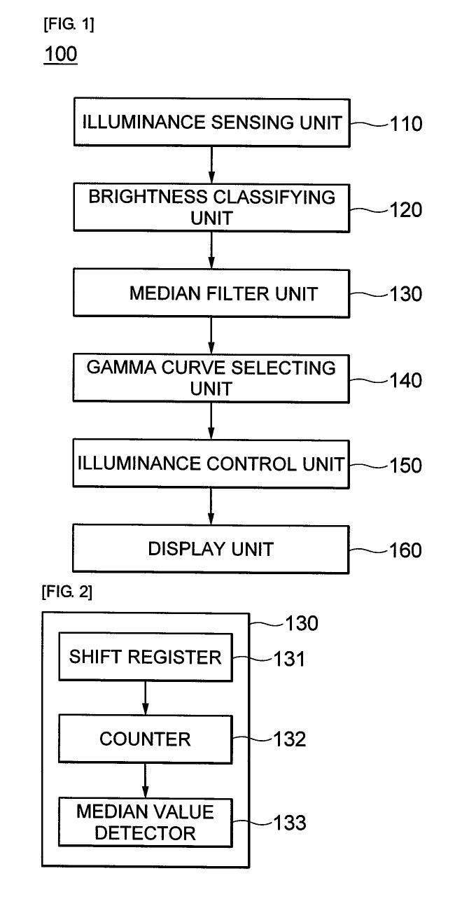

FIG. 1 is a schematic diagram illustrating a structure of the automatic brightness control device in accordance with the embodiment of the present invention.

As shown in FIG. 1, the automatic brightness control device 100 in accordance with the embodiment of the present invention includes an illuminance sensing unit 110, a brightness classifying unit 120, a median filter unit 130, a gamma curve selecting unit 140, an illuminance control unit 150 and a display unit 160.

Firstly, the illuminance sensing unit 110 can sense an external illuminance value in real time by using a sensor, and the brightness classifying unit 120 can classify the illuminance value sensed by the illuminance sensing unit 110 into two or more configured brightness levels by comparing the sensed illuminance value with a reference illuminance value.

For instance, in the case where the reference illuminance value is configured as three voltage levels, i.e., VI, Vm and Vh, in the brightness classifying unit 120, the illuminance value sensed by the illuminance sensing unit 110 is compared with each voltage level of VI, Vm and Vh to be classified into four brightness levels, i.e., ‘very dark’, ‘dark’, ‘indoor’ and ‘outdoor’.

That is, in the case where the sensed illuminance value of the illuminance sensing unit 110 is lower than VI, equal to or higher than VI and lower than Vm, equal to or higher than Vm and lower than Vh, equal to or higher than Vh, it can be classified into ‘very dark’, ‘dark’, ‘indoor’ and ‘outdoor’ respectively.

The median filter unit 130 can eliminate a noise factor by filtering a median value among the classified brightness levels. A method of filtering the median value in the median filter unit 130 is described below.

The gamma curve selecting unit 140 selects a gamma curve which corresponds to the median value filtered by the median filter unit 130, and the illuminance control unit 150 can adjust the illuminance.

Generally, the smaller a gamma value is, the brighter an image is. If the gamma value becomes larger, the image becomes dark. Herein, the gamma value is defined as a log ratio of input/output characteristics at an electrical-to-optical converter and shows picture brightness.

The gamma curve selecting unit 140 selects the gamma curve having a relatively larger gamma value as the filtered median value becomes large and selects the gamma curve having a relatively smaller gamma value as the filtered median value becomes small.

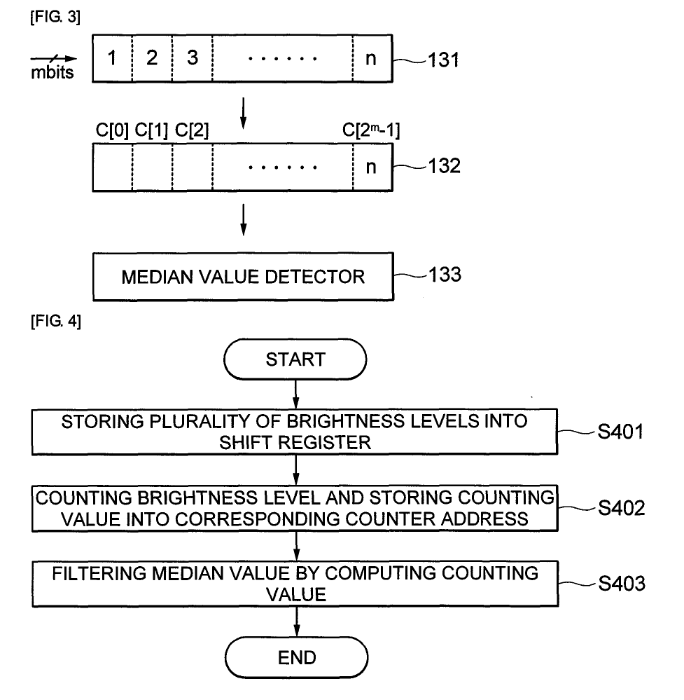

FIG. 2 is a schematic diagram illustrating a structure of the median filter or median filter unit in accordance with the embodiment of the present invention, and FIG. 3 is a diagram for explaining each element of the median filter or median filter unit in accordance with the embodiment of the present invention.

As shown in FIGS. 2 and 3, the median filter unit 130 in accordance with the embodiment of the present invention includes a shift register 131, a counter 132 and a median value detector 133.

Firstly, the shift register 131 can store the classified brightness level which corresponds to the external illuminance value sensed in real time. The shift register 131 stores a sequentially inputted brightness level into each tab. For instance, the number of tabs of the shift register 131 can be configured as n.

As shown in FIG. 3, the brightness level can be shown as a data having a size of m bits, and each m-bit data can be stored in the n tabs. That is, the shift register 131 can be provided with a storing space capable of storing n numbers of brightness levels of sensed illuminance value.

The counter 132 sequentially counts the brightness level stored in the shift register 131 and stores a counting value which corresponds to the number of each brightness level into a counter address of the brightness level.

For instance, in the case where the brightness level is a m-bit data, 2^{m} addresses of the counter 132 can be allotted.

Herein, the counting address can be determined according to a data size of the brightness level classified by the brightness classifying unit 120, and the counting value can be accumulated by sequentially counting the brightness level stored in the shift register 131.

For instance, in the case where the brightness level is a 3-bit data and the number of the tabs of the shift register 131 is 10, the counting address can be determined as C[0], C[1], C[2], . . . , C[2³−1].

In the case where the brightness level is a 3-bit data, and the number of the tabs of the shift register 131 is 10, and the data of the brightness level is inputted to the shift register 131 in an arranged sequence shown below, the counting address and the counting value stored in each counting address are shown below.

Data of the brightness level stored in the shift register->111, 101, 100, 101, 100, 111, 100, 010, 001, 000

Counting address->C[0], C[1], C[2], C[3], C[4], C[5], C[6], C[7]

Counting value->1, 1, 1, 0, 3, 2, 0, 2

That is, the smallest value 000 among the sizes of the 3-bit data is configured as the counting address C[0], 001 is configured as C[1] and so on. In this manner, the counting address can be determined.

Also, the counting value can be calculated by sequentially counting the data of the brightness level stored in the shift register 131 and accumulating the counting value of the corresponding counting address from “0” by “+1”.

The median value detector 133 can filter the median value by computing the counting value, and the median value detector 133 compares the sequentially accumulated value of the counting value with a value derived by dividing the number of storing spaces of the shift register 131 by 2 in order to filter the median value of the brightness level.

In the case where the sequentially accumulated value of the counting value is larger than the value derived by dividing the number of storing spaces of the shift register 131 by 2, the brightness level which corresponds to the counter address where a lastly accumulated counting value among the sequentially accumulated counting value is stored can be filtered as the median value.

In the above-mentioned example, a process of obtaining the filtered median value of the brightness level is explained as follows.

Firstly, if the counting value “1” stored in C[0] is compared with n/2 (5), since the counting value “1” is smaller than 5 derived by dividing the number of storing spaces (tabs) of the shift register 131 by 2, the counting value stored in C[0] and the counting value “1” stored in C[1] are accumulated.

The counting value of C[0]+the counting value of C[1] is “2”. Since this is smaller than 5 derived by dividing the number of storing spaces (tabs) of the shift register 131 by 2, the counting value “1” stored in C[2] is added again.

In the same manner, C[4] is the counter address in which the sequentially accumulated counting value is larger than 5 derived by dividing the number of storing spaces (tabs) of the shift register 131 by 2. Since the brightness level which corresponds to C[4] is “100”, the median value is the brightness level of “100”.

Accordingly, the automatic brightness control device in accordance with the present invention can automatically control the brightness of an inputted image by selecting the gamma curve which corresponds to the median value “100”.

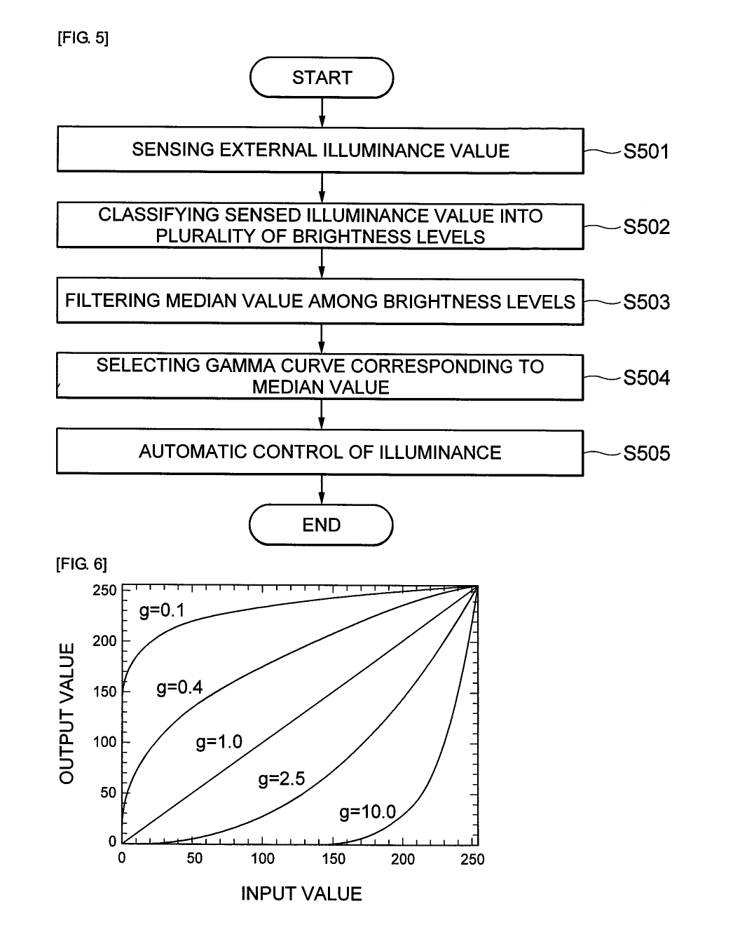

FIG. 4 is a flow chart diagram illustrating a method of computing the median value in accordance with the embodiment of the present invention, and FIG. 5 is a flow chart diagram illustrating a method of automatic brightness control in accordance with the embodiment of the present invention.

As shown in FIG. 4, according to the median value computing method in accordance with the present invention, a plurality of brightness levels is stored in the shift register (S401), and after storing the counting value derived by counting the stored brightness levels into the corresponding counter address (S402), the median value can be filtered by computing the counting value (S403).

For explaining in detail, at the step (S401) where the plurality of brightness levels is stored in the shift register, the illuminance sensing unit senses the external illuminance value in real time, and the sensed illuminance value is classified into the plurality of brightness levels.

That is, the brightness level can be determined by classifying cases where the sensed illuminance value is higher and lower than the reference illuminance value by comparing the sensed illuminance value with the reference illuminance value.

For instance, in the case where the reference illuminance value is set to Vh and VI, the sensed illuminance value can be classified into three cases of brightness levels where the sense illuminance value is lower than VI, equal to or higher than VI and lower than Vh, and equal to or higher than Vh.

At the step (S402) where the counting value obtained by counting the stored brightness level is stored into the corresponding counter address, the counting value can be stored into the counter address of the brightness level by sequentially counting the brightness level stored in the shift register.

Herein, the counting value means the number of sizes of the brightness level which correspond to the counter address.

That is, at the counter, by sequentially counting the stored brightness level, the counting value corresponding to each brightness level can be stored in the counter address corresponding to ascending order of the brightness level.

For instance, in the case where the brightness level stored in the shift register is 3, 1, 1, 1, 2, 4, 2, 4, 4, the counting value (3) of the brightness level size ‘1’ is stored in the counter address C[0]; the counting value (2) of the brightness level size ‘2’ is stored in the counter address C[1]; the counting value (1) of the brightness level size ‘3’ is stored in the counter address C[3]; and, the counting value (3) of the brightness level size ‘4’ is stored in the counter address C[4].

At the step (S403) for filtering the median value by computing the counting value, the median value is filtered by computing the stored counting value.

According to a method of computing the counting value, the counting value stored in the counter address is sequentially accumulated, and the accumulated value is compared with the value obtained by dividing the number of storing spaces (tabs) of the shift register by 2.

In the case where the sequentially accumulated value of the counting value is larger than the value obtained by dividing the number of storing spaces of the shift register by 2 when the sequentially accumulated value is compared with the value obtained by dividing the number of storing spaces of the shift register by 2, the brightness level stored in the counter address where the lastly accumulated counting value among the sequentially accumulated counting value is stored can be filtered as the median value.

For instance, the counting value ‘3’ of C[0] is compared with the value obtained by dividing the number of storing spaces of the shift register by 2. If the accumulated value is smaller than the value obtained by dividing the number of storing spaces of the shift register by 2, a next counting value is accumulated.

Next, a value of ‘5’ obtained by accumulating the counting value ‘3’ of C[0] and the counting value ‘2’ of C[1] is compared with ‘9/2’. In the case where the accumulated value is larger than the value obtained by dividing the number of storing spaces of the shift register by 2, the brightness level stored in the counter address where the accumulated counting value is stored is filtered as the median value.

Accordingly, ‘2’ which is the brightness level of C[1] is filtered as the median value.

As shown in FIG. 5, according to the method of automatic brightness control in accordance with the embodiment of the present invention, the external illuminance value is sensed (S501), the sensed illuminance value is classified into the plurality of brightness levels (S502), and the median value among the classified brightness levels is filtered.

The method of filtering the median value by sensing the external illuminance value and classifying the sensed illuminance value into the plurality of brightness levels has been described above.

If the median value is filtered, the gamma curve corresponding to the filtered median value is selected (S504), and the illuminance of the inputted image can be automatically adjusted according to the selected gamma curve.

FIG. 6 is a diagram illustrating the gamma curve for use in the automatic brightness control device in accordance with the embodiment of the present invention.

As shown in FIG. 6, the gamma curve shows various forms according to various gamma values (g), and an output value and an input value are normalized as values from 0 to 250.

That is, a larger gamma value shows a darker image and a smaller gamma value shows a brighter image.

In the case where the externally sensed illuminance value is high, the gamma curve having a low gamma value is selected; and in the case where the externally sensed illuminance value is low, the gamma curve having a high gamma value is selected.

At this time, if the gamma curve having the low gamma value is selected, an overall brightness value in each gradation of a display panel becomes high. On the contrary, if the gamma curve having the high gamma value is selected, the brightness value in each gradation of the display panel becomes low.

Accordingly, since the corresponding gamma curve is different according to the filtered median value, the brightness of the display panel can be automatically adjusted.

In accordance with the embodiment of the present invention, by designing the median filter to use the counting method, the amount of computing operation for filtering the median value can be reduced, and a noise factor of circumferential brightness can be controlled, and a response speed can be increased.

Also, a structure is simple and a size can be reduced. It can be more efficiently operated when the number of data stored in the shift register is increased.

Also, it has an effect of automatically controlling the illuminance of the inputted image by selecting the gamma curve which corresponds to the median value filtered by the median filter.

Although the preferable embodiments of the present invention have been shown and described above, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An automatic brightness control device, comprising:
an illuminance sensing unit for sensing an external illuminance value in real time;
a brightness classifying unit for classifying the illuminance value sensed in real time by the illuminance sensing unit into two or more configured brightness levels by comparing the sensed illuminance value with a reference illuminance value;
a median filter unit for filtering a median value among the brightness levels classified by the brightness classifying unit;
a gamma curve selecting unit for selecting a gamma curve which corresponds to the median value filtered by the median filter unit; and
an illuminance control unit for controlling illuminance according to the gamma curve selected by the gamma curve selecting unit.

2. The automatic brightness control device of claim 1, wherein the median filter unit includes:
a shift register for storing the brightness levels classified by the brightness classifying unit corresponding to the illuminance value sensed in real time;
a counter for storing a counting value which corresponds to the number of each brightness level into a counter address of the brightness level by sequentially counting the brightness levels stored in the shift register; and
a median value detector for filtering the median value by computing the stored counting value.

3. The automatic brightness control device of claim 2, wherein the shift register is provided with storing space capable of storing the brightness levels of N sensed illuminance values.

4. The automatic brightness control device of claim 2, wherein the counter accumulates the counting value stored in the counter address by sequentially counting the brightness levels stored in the shift register.

5. The automatic brightness control device of claim 2, wherein the counter address is determined according to a data size of the brightness levels classified by the brightness classifying unit.

6. The automatic brightness control device of claim 2, wherein the median value detector filters the median value of the brightness level by comparing a value of sequentially accumulating the stored counting value with a value of dividing the number of storing space of the shift register by 2.

7. The automatic brightness control device of claim 6, wherein the median value detector, in the case where the sequentially accumulated value of the counting value is larger than the value of dividing the number of storing space of the shift register by 2, filters the brightness level which corresponds to the counter address where a lastly accumulated counting value among the sequentially accumulated counting value is stored as the median value.

8. The automatic brightness control device of claim 2, wherein 2^{m} numbers of the counter address are allotted in the case where the brightness level is an m-bit data.

9. The automatic brightness control device of claim 1, wherein the gamma curve selecting unit selects the gamma curve having a relatively large gamma value as the filtered median value is larger.

10. The automatic brightness control device of claim 1, further comprising a display unit for outputting an illuminance-adjusted input image.

11. A median filter, comprising:
a shift register for classifying an external illuminance value sensed in real time into a plurality of brightness levels by comparing the external illuminance value with a reference illuminance value and for storing the classified brightness levels;
a counter for storing a counting value which corresponds to the number of each brightness level into a counter address of the brightness level by sequentially counting the brightness levels stored in the shift register; and
a median value detector for filtering the median value by computing the stored counting value.

12. The median filter of claim 11, wherein the shift register is provided with storing space capable of storing the brightness levels of N sensed illuminance values.

13. The median filter of claim 11, wherein the counter accumulates the counting value stored in the counter address by sequentially counting the brightness levels stored in the shift register.

14. The median filter of claim 11, wherein the counter address is determined according to a data size of the brightness levels classified by the brightness classifying unit.

15. The median filter of claim 11, wherein the median value detector filters the median value of the brightness level by comparing a value of sequentially accumulating the stored counting value with a value of dividing the number of storing space of the shift register by 2.

16. The median filter of claim 15, wherein, in the case where the sequentially accumulated value of the counting value is larger than the value of dividing the number of storing space of the shift register by 2, the brightness level which corresponds to the counter address where a lastly accumulated counting value among the sequentially accumulated counting value is stored is filtered as the median value.

17. The median filter of claim 11, wherein 2^{m} numbers of the counter address are allotted in the case where the brightness level is an m-bit data.

18. A method of computing a median value, comprising:
a step of sensing an external illuminance value in real time at an illuminance sensor unit and classifying the sensed illuminance value into a plurality of brightness levels and storing the plurality of brightness levels into a shift register;
a step of storing a counting value corresponding to the number of each brightness level into a counter address of the brightness level by sequentially counting the brightness levels stored in the shift register at a counter; and
a step of filtering the median value by computing the stored counting value.

19. The method of computing the median value of claim 18, wherein at the step of storing the counting value corresponding to each brightness level into the counter address corresponding to ascending order of the brightness level by sequentially counting the brightness levels stored in the shift register at the counter, the counting value stored in the counter address is accumulated by sequentially counting the brightness level stored in the shift register.

20. The method of computing the median value of claim 18, wherein the step of filtering the median value by computing the stored counting value includes:
a step of comparing a value of sequentially accumulating the stored counting value with a value of dividing the number of storing space of the shift register by 2; and
a step of filtering the brightness level stored in the counter address where a lastly accumulated counting value among the sequentially accumulated counting value is stored as the median value in the case where the sequentially accumulated value of the counting value is larger than the value of dividing the number of storing space of the shift register by 2.

21. A method of automatic brightness control, comprising:
a step of sensing an external illuminance value in real time;
a step of classifying each illuminance value sensed in real time into two or more configured brightness levels by comparing the sensed illuminance value with a reference illuminance value;
a step of filtering a median value among the classified brightness levels; and
a step of adjusting illuminance by selecting a gamma curve corresponding to the filtered median value.

22. The method of automatic brightness control of claim 21, wherein the step of filtering the median value among the classified brightness levels includes:
a step of sensing an external illuminance value in real time at an illuminance sensor unit and classifying the sensed illuminance value into a plurality of brightness levels and storing the plurality of brightness levels into a shift register;
a step of storing a counting value corresponding to the number of each brightness level into a counter address of the brightness level by sequentially counting the brightness levels stored in the shift register at a counter; and
a step of filtering the median value by computing the stored counting value.

23. The method of automatic brightness control of claim 22, wherein at the step of storing the counting value corresponding to each brightness level into the counter address corresponding to ascending order of the brightness level by sequentially counting the brightness levels stored in the shift register at the counter, the counting value stored in the counter address is accumulated by sequentially counting the brightness level stored in the shift register.

24. The method of automatic brightness control of claim 22, wherein the step of filtering the median value by computing the stored counting value includes:
a step of comparing a value of sequentially accumulating the stored counting value with a value of dividing the number of storing space of the shift register by 2; and
a step of filtering the brightness level stored in the counter address where a lastly accumulated counting value among the sequentially accumulated counting value is stored as the median value in the case where the sequentially accumulated value of the counting value is larger than the value of dividing the number of storing space of the shift register by 2.
